(19) United States
(12) Patent Application Publication
(10) Pub. No.: US 2024/0244299 A1
(43) Pub. Date: Jul. 18, 2024

(54) CONTENT PROVIDING METHOD AND APPARATUS, AND CONTENT PLAYBACK METHOD

(71) Applicant: INDUSTRY-ACADEMIA COOPERATION GROUP OF SEJONG U, Seoul (KR)

(72) Inventor: Oh Jin KWON, Hanam si (KR)

(21) Appl. No.: 18/031,201

(22) PCT Filed: Sep. 6, 2021
(86) PCT No.: PCT/KR2021/012034

§ 371 Date: Dec. 14, 2023

(30) Foreign Application Priority Data
Oct. 12, 2020 (KR) 10-2020-0130849

(51) Int. Cl. H04N 21/488

(52) U.S. Cl. CPC H04N 21/4884

(57) ABSTRACT

The present disclosure provides a content providing method and apparatus for distributing a video content in which audio or captions are added to an original content that enable a content consumer to exclude the audio and captions added to the original content and restore the original content. According to an embodiment of the present disclosure, a plurality of video objects into which a video is divided based on cuts, a plurality of audio clip objects included in the video, a plurality of caption clip objects included in the video, video object attribute information, audio clip attribute information, and caption clip attribute information are stored in a format of a video content frame having a predetermined structure and transmitted to a receiving device, so that the receiving device may reproduce the video content by selectively combining only necessary content elements.

### TECHNICAL FIELD

The present disclosure relates to a method of distributing content and, more particularly, to a method of encoding and distributing small-sized video content reproduced for a short period of time. In addition, the present disclosure relates to a method of reproducing content files or streams distributed as such.

### BACKGROUND

Snack culture refers to a lifestyle or cultural trend of enjoying cultural life within 5 to 15 minutes which is a short time comparable to time spent for eating snacks. Also, such a short content which may be consumed in a short time is referred to as snack culture content. Examples of the snack culture content may include webtoons, web novels, web dramas, and edited or summarized videos. Most of the content distributed through video sharing platforms such as You Tube (trademark) may belong to the snack culture content. The production and use of the snack culture content are increasing because portable device users can easily enjoy them during short free time such as commuting time using public transportation.

Most snack culture content are video content produced by inserting audio, captions, or cursors into original content such as a still image and a moving picture. The audio, captions, or cursors added to original content may often contain exaggerated or provocative content to attract the attention of content consumers. The content consumer may wish to edit the content to remove at least some part of the audio, captions, or cursors added to the original content to restore and reproduce edited content, or re-edit the original content. However, since the audio, captions, or cursors are already overlaid and combined with the original content in the content delivered to the content consumer, it may be impossible to restore the original content in most cases.

### DETAIL DESCRIPTION OF THE INVENTION

### Technical Problems to be Solved

To solve the problems above, provided are a content providing method and apparatus for distributing a video content in which audio or captions are added to an original content that enable a content consumer to exclude the audio and captions added to the original content and restore the original content.

Also, provided is a method for reproducing the original content by excluding the audio or captions from the video content distributed as described above.

### Means for Solving Problems

According to an aspect of an exemplary embodiment, a video content providing method includes: acquiring a plurality of video objects into which a video is divided based on cuts and video object attribute information for each of the plurality of video objects; separating a plurality of audio clip objects included in the video and acquiring audio clip attribute information for each of the plurality of audio clip objects; separating a plurality of caption clip objects included in the video and acquiring caption clip attribute information for each of the plurality of caption clip objects; encoding the plurality of video objects, the plurality of audio clip objects, and the plurality of caption clip objects separately to generate a plurality of encoded video objects, a plurality of encoded audio clip objects, and a plurality of encoded caption clip objects; and storing information of the plurality of encoded video objects, information of the plurality of encoded audio clip objects, information of the plurality of encoded caption clip objects, the video object attribute information, the audio clip attribute information, and the caption clip attribute information in a format of a video content frame having a predetermined structure and transmitting the video content frame to a receiving device. The cuts may be classified into one of a static cut, a dynamic cut, and a transition cut according to a predetermined rule.

The video object attribute information, the audio clip attribute information, and the caption clip attribute information may include relative time information required for synchronizing and reproducing the plurality of video objects, the plurality of audio clip objects, and the plurality of caption clip objects in the receiving device.

The audio clip objects may include a first audio clip object included in an original video of the plurality of video objects and a second audio clip object not included in the original video and added as a narration or sound effect.

The audio clip attribute information may include information indicating which of the first audio clip object and the second audio clip object the audio clip object is.

The first audio clip object may be encoded together with a corresponding video object to be stored in the video content frame.

The information of the plurality of encoded video objects may be resource location information of the plurality of encoded video objects. The information of the plurality of encoded audio clip objects may be resource location information of the plurality of encoded audio clip objects. The information of the plurality of encoded caption clip objects may be resource location information of the plurality of coded caption clip objects.

The information of the plurality of encoded video objects may be a code stream of respective one the plurality of encoded video objects. The information of the plurality of encoded audio clip objects may be a code stream of the plurality of encoded audio clip objects. The information of the plurality of encoded caption clip objects may be a code stream of respective one of the plurality of encoded caption clip objects.

According to an aspect of an exemplary embodiment, a video content providing apparatus includes: a memory storing program instructions; and a processor communicatively coupled to the memory and executing the program instructions stored in the memory. The program instructions, when executed by the processor, causes the processor to: acquire a plurality of video objects into which a video is divided based on cuts and video object attribute information for each of the plurality of video objects; separate a plurality of audio clip objects included in the video to acquire audio clip attribute information for each of the plurality of audio clip objects; separate a plurality of caption clip objects included in the video to acquire caption clip attribute information for each of the plurality of caption clip objects; encode the plurality of video objects, the plurality of audio clip objects, and the plurality of caption clip objects separately to generate a plurality of encoded video objects, a plurality of encoded audio clip objects, and a plurality of encoded caption clip objects; and store information of the plurality of encoded video objects, information of the plurality of encoded audio clip objects, information of the plurality of encoded caption clip objects, the video object attribute information, the audio clip attribute information, and the caption clip attribute information in a format of a video content frame having a predetermined structure to transmit the video content frame to a receiving device.

According to an aspect of an exemplary embodiment, a video content playback method includes: receiving, from a transmitting device, a video content frame including information on a plurality of encoded video objects, information on a plurality of encoded audio clip objects, information on a plurality of encoded caption clip objects, video object attribute information, audio clip attribute information, and caption clip attribute information; separating the video object attribute information, the audio clip attribute information, and the caption clip attribute information from the video content frame and acquiring the plurality of encoded video objects, the plurality of encoded audio clip objects, and the plurality of encoded caption clip objects based on the video content frame; decoding the plurality of encoded video objects, the plurality of encoded audio clip objects, and the plurality of encoded caption clip objects to acquire a plurality of video objects, a plurality of audio clip objects, and a plurality of caption clip objects, respectively; and combining at least some of the plurality of video objects, the plurality of audio clip objects, and the plurality of caption clip objects according to the video object attribute information, the audio clip attribute information, and the caption clip attribute information to reconstruct and output a video content.

The objects included in the video content among the plurality of video objects, the plurality of audio clip objects, and the plurality of caption clip objects may be determined in response to a user's selection input.

According to an embodiment of the present disclosure, a content consumer using short-length video content to which an audio or caption is added may reproduce the video content in a state that the audio or caption is excluded from the video content. Accordingly, the content consumer may passively reproduce the video content as well as reproduce the content in a concise form or use it in a different way, or may re-edit the original video content. Therefore, the present disclosure may diversify use methods of the video content and enhance the utilization of the content.

### BRIEF DESCRIPTION OF THE DRAWINGS

FIG. 1 is a flowchart showing a general process of generating short content such as snack culture content;

FIG. 2 is a functional block diagram of a video content providing apparatus according to an exemplary embodiment of the present disclosure;

FIG. 3 shows examples of temporal durations of content elements;

FIG. 4 is a table summarizing an example of information extracted for each content element;

FIG. 5 illustrates an example of a video content frame generated by a formatter shown in FIG. 2;

FIG. 6 is a block diagram showing a physical configuration of the video content providing apparatus shown in FIG. 2;

FIG. 7 is a flowchart illustrating a video content providing method according to an exemplary embodiment of the present disclosure; and

FIG. 8 is a functional block diagram of a video content reproducing apparatus according to an exemplary embodiment of the present disclosure.

### DETAILED DESCRIPTION

For a clearer understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure. In order to facilitate general understanding in describing the present disclosure, the same components in the drawings are denoted with the same reference signs, and repeated description thereof will be omitted.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Exemplary embodiments of the present disclosure will now be described in detail with reference to the accompanying drawings.

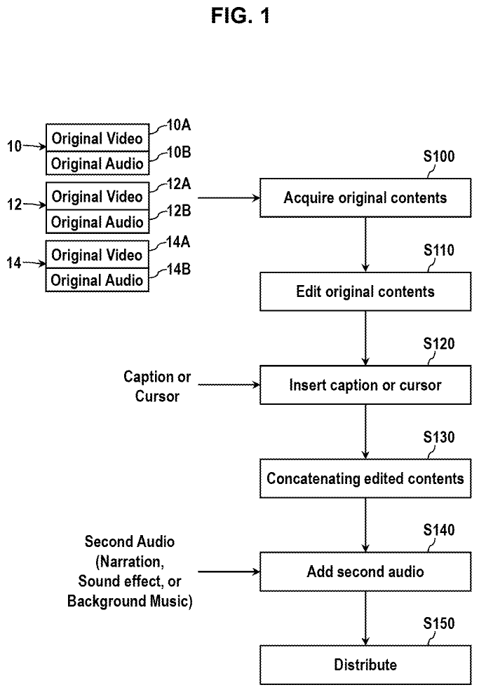

FIG. 1 illustrates a general process of generating short content such as snack culture content.

A creator who intends to create a video content first acquires one or more original content 10, 12, and 14 (operation 100). Each of the original contents 10, 12, and 14 may include an original video 10A, 12A, or 14A and an original audio 10B, 12B, or 14B. The original contents 10, 12, and 14 may be acquired on the Internet or may be created by photographing by the creator or a colleague of the creator. However, the acquisition of the original contents is not limited to these methods. On the other hand, in the present disclosure, it is assumed that the creation of a secondary work by the creator or a content consumer using the video content created by the creator does not cause a copyright-related problem due to waivers of copyrights or use permissions for the original contents.

Next, the creator may edit the original contents 10, 12, and 14 acquired in the operation 100 (operation 110). Each of the original contents 10, 12, and 14 may include one or more scenes. When the original content includes two or more scenes, the creator may edit the original content by each scene. Examples of editing of the scenes may include an adjustment of a temporal length, screen size, brightness and/or contrast, sharpening, color correction of the content.

After the editing of the video content is completed, the creator may insert a caption or a cursor into the video content (operation 120). The creator may specify a font, size, background, transparency, and other effects of the caption added into the video content.

Subsequently, the creator may combine two or more original contents 10, 12, and 14 by concatenating edited original contents (operation 130). When the original contents 10, 12, and 14 are combined together, the creator may introduce a transition effect for a smooth scene transition. Examples of the transition effect may include ‘Matching cut’ in which two scenes are cut and connected such that motions in the scenes are continued smoothly to maintain a continuity of the motions, ‘Fade-in/Fade-out’ where a new scene become brighter gradually while a previous scene fade away, ‘Dissolve’ where two scenes intersect as Fade in and Fade out, ‘Push’ where a new screen comes in as if being pushed into, ‘Wipe’ where one scene is replaced by another scene from one side of a frame to another side, ‘Iris’ which is a wipe transition that takes a form of a growing or shrinking circle, and ‘Wash out’ where the screen gradually turns white and disappears and is followed by a new scene.

The creator may combine a narration input through a microphone, other sound effects, or background music with content into which the plurality of scenes have been concatenated (operation 140). In order to distinguish the original audio 10B, 12B, and 14B included in the original content 10, 12, and 14 and the audio inserted by the creator, the audio 10B, 12B, and 14B included in the original content 10, 12, and 14, respectively, are referred as a first audio and the audio inserted by the creator is referred to as a second audio hereinafter.

After the completion of the operation 140, the generation of video content which includes the caption or cursor and the second audio in addition to the edited original content is completed, and this video content may be delivered to a content consumer in a file format or by streaming to be played by the consumer (operation 150). Although the operations 100-140 are arranged sequentially in FIG. 1 for convenience of description, the order of the operations may be changed or vary and the operations may be performed repeatedly in various orders.

When the video content is generated according to the present disclosure, content elements such as the caption, cursor, and the second audio are reversibly combined to the original video content rather than being combined irreversibly. That is, the content consumer may restore the original video content and the other content elements from the received video content in the process of reconstructing the video content.

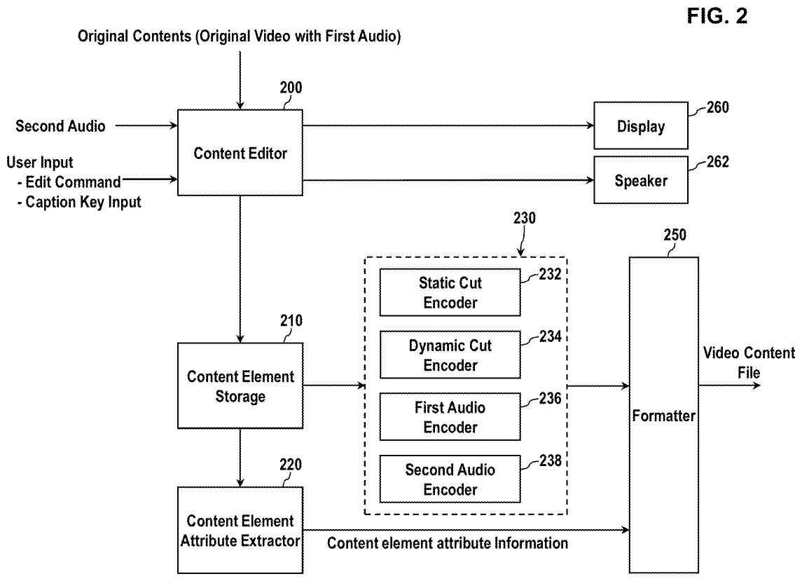

FIG. 2 is a functional block diagram of a video content providing apparatus according to an exemplary embodiment of the present disclosure. The video content providing apparatus may include a content editor 200, a content element storage 210, a content element attribute extractor 220, an encoder 230, a formatter 250, a display 260, and a speaker 262.

According to the present embodiment, the video content providing apparatus may generate the video content in a form in which content elements and their composition are formatted instead of a form in which the content elements are irreversibly combined. The content elements may include still images, video, the first and the second audios, captions, or cursors and may implement the video content in a combined form. That is, the video content providing apparatus may separately encode the still images, the videos, the first and the second audios and add attribute information of content elements such as the still images, the videos, the first and the second audios, the captions, and the cursors to generate and output the video content in a file or data frame form. Accordingly, a device receiving the video content completes and display the video content by combining the content elements based on information of each content element. Also, the device may extract and use only some of the content elements as needed.

The content editor 200 receives the original contents 10, 12, and 14, the second audio signal, and caption and cursor information, and performs a video editing according to creator's manipulations of the device to generate the video content. That is, the content editor 200 performs the operations 100-140 shown in FIG. 1 to edit each cut of the original contents 10, 12, and 14, insert the caption or the cursor, and concatenate the original contents 10, 12, and 14, and add the second audio such as the narration, the sound effects, or the background music. During the video editing or after the video editing is completed, the video content generated by the content editor 200 may be output through the display 260 and the speaker 262 to allow the creator to check the edited content.

The content element storage 210 may store each content element to be used to generate the video content in a memory or a storage device while the video content is being created by the content editor 200. Here, the content element may include the video, the still image, the first audio, the second audio, the caption, and the cursor. The content element attribute extractor 220 may extract the attribute of each content element stored by the content element storage 210 to store in the memory or the storage device.

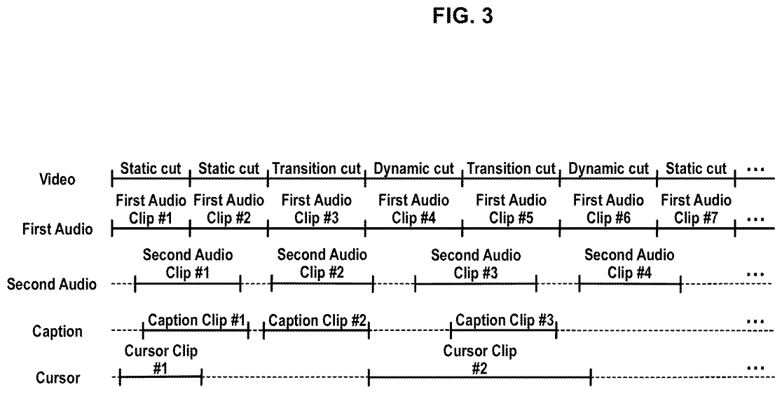

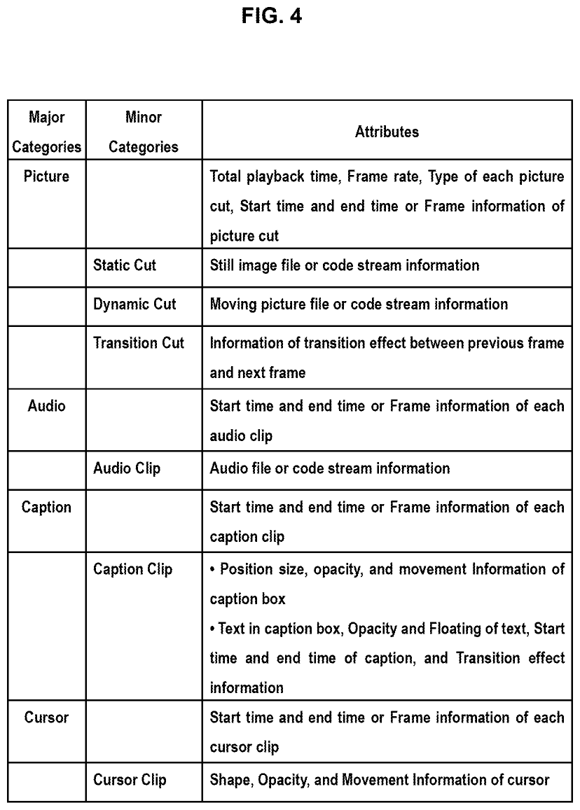

The separation of content elements and the extraction of information of each content element will now be described with reference to FIGS. 3 and 4. FIG. 3 shows examples of temporal durations of the content elements. FIG. 4 is a table summarizing an example of information extracted for each content element.

In an exemplary embodiment, videos may be categorized into three types of cuts: a static cut, i.e., a still image, a dynamic cut, i.e., a moving picture, and a transition cut. The static cuts, the dynamic cuts, and the transition cuts may be separated according to following rules.
(1) Rule for the static cut: Consecutive frames of the same still images belong to a single independent static cut.
(2) Rule for the dynamic cut: When the original video content is a moving picture, frames captured by a camera for the same scene from a timing when the camera is turned on to a timing when the camera is turned on belong to an independent dynamic cut.
(3) Rule for the transition cut: When a transition effect operates between the static cuts, between the dynamic cuts, or between a static cut and a dynamic cut, the frames in a duration of the transition effect belong to an independent transition cut.
(4) An entire video is a collection of consecutive cuts. That is, each of all the frames belongs to a single cut, and two or more consecutive cuts may be of the same kind.

The audio may be composed of a plurality of audio clips, and a starting point and an ending point of each audio clip may be synchronized with a frame of the video. The audio clips may not be continuous unlike the picture cuts associated with the audio clips.

The caption may be composed of a plurality of caption clips, and a start and an end of each caption clip may be synchronized with one or more video frames. The caption clips may not be continuous unlike the picture cuts. Each caption may occupy a caption box which is a certain area of a rectangular shape on the image. The caption box is a portion of the image on which the caption is displayed. The caption box can be moved within the image, the transparency of the caption box may be adjusted. The opacity of the caption itself may also be adjusted, and the caption may slide horizontally or vertically in the caption box or may be displayed with the transition effect in synchronicity with the video frames.

The cursor may be composed of a plurality of cursor clips, and a start and an end of each cursor clip may be synchronized with one or more video frames. The cursor clips may not be continuous unlike the picture cuts. Each cursor clip may be displayed in a different shape. The opacity of the cursor may be adjusted, and the position of the cursor may be moved in synchronicity with the video frames.

Referring to FIG. 4, the content element attribute extractor 220 may extract, for each picture cut, the attribute information such as a total playback time, a frame rate (frame/see), the type of each picture cut, a start time and an end time of the picture cut, or frame information. In case of the static cut, a still image may be encoded, so that a still image file or code stream in which the still image is encoded may be included in the video content along with the attribute information. In case of the dynamic cut, a moving picture may be encoded, so that moving picture file or code stream in which the moving picture is encoded may be included in the video content. In case of the transition cut, the information of the transition effect between the previous frame and the next frame or a transition picture may be encoded, so that a file or code stream in which the transition effect information is encoded may be included in the video content.

In the case of audio, a start time and an end time or frame information of each audio clip may be extracted as the attribute information. In addition, for each audio clip, the audio may be encoded, so that a file or code stream in which the audio of the audio clip is encoded may be included in the video content. In an exemplary embodiment, the attribute information is extracted separately for the first audio included in the original content 10, 12, and 14 and the second audio inserted by the creator, and the file or code stream in which the audio is encoded may be generated and extracted separately. Alternatively, the first audio may be encoded together with the video, or maintain the original encoded state.

In the case of the caption, a start time and an end time or frame information of each caption clip may be extracted as the attribute information. In addition, for each caption clip, information on a position, a size, a transparency, and a motion of the caption box, a text in the caption box, an opacity and floating of the text, the start time and the end time of the caption, and a transition effect information may be extracted as the attribute information to be included in a final video content file or encoded separately.

In the case of the cursor, a start time and an end time or frame information of each cursor clip may be extracted as attribute information. In addition, for each cursor clip, a shape, an opacity and a movement of the cursor may be extracted as the attribute information to be included in a final video content file or encoded separately.

Referring back to FIG. 2, the encoder 230 receives the content elements such as the static cut, the dynamic cut, the first and the second audio, and the caption from the content element storage 210 and encodes each of the content elements. The encoder 230 may include a static cut encoder 232, a dynamic cut encoder 234, a first audio encoder 236, and a second audio encoder 238. The static cut encoder 232 may encode the still image for each static cut to generate encoded static cut image data. The dynamic cut encoder 234 may encode the video for each dynamic cut to generate encoded dynamic cut video data. The first audio encoder 236 may encode each of the audio clips of the first audio to generate encoded first audio data. The second audio encoder 238 may encode each of the audio clips of the second audio to generate encoded second audio data.

The static cut encoder 232, the dynamic cut encoder 234, the first audio encoder 236, and the second audio encoder 238 may be configured to conform to existing and widely used coding standards. Also, the first audio encoder 236 may be integrated into the dynamic cut encoder 234. Meanwhile, the encoder 230 may further include a transition cut encoder, a caption encoder, and a cursor encoder for encoding the transition cut, the caption clip, and the cursor clip, respectively.

The formatter 250 combines the encoded static cut image data, the encoded dynamic cut video data, the encoded first audio data, and the encoded second audio data output by the encoder 230, along with the attribute information for each content element extracted by the content element attribute extractor 220 into a single video content frame or a file.

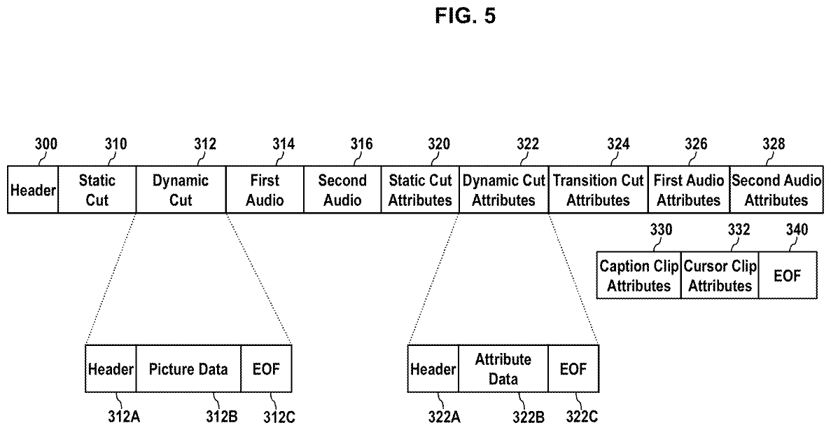

FIG. 5 illustrates an example of a video content frame generated by the formatter 250. The video content frame includes a header 300, a static cut image data field 310, a dynamic cut video data field 312, a first audio data field 314, a second audio data field 316, and a static cut attribute information field 320, a dynamic cut attribute information field 322, a transition cut attribute information field 324, a first audio attribute information field 326, a second audio attribute information field 328, a caption clip attribute information field 330, a cursor clip attribute information field 332, and an end-of-frame indicator 340. The header 300 may include information such as a frame start indicator, a file name, a number of image cuts, a number of the first and the second audio clips, a number of the caption clips, and a number of the cursor clips. The static cut image data field 310, the dynamic cut video data field 312, the static cut attribute information field 320, the dynamic cut attribute information field 322, and the transition cut attribute information field 324 may be provided as much as the number of corresponding image cuts. The first and the second audio data fields 314 and 316, the first audio attribute information field 326, the second audio attribute information field 328, the caption clip attribute information field 330, and the cursor clip attribute information field 332 may be provided as many as the number of corresponding clips.

In an exemplary embodiment, at least some of the static cut image data field 310, the dynamic cut video data field 312, the first audio data field 314, and the second audio data field 316 may include a code stream, i.e., actual data of the encoded static cut image data, the encoded dynamic cut video data, the encoded first audio data, or the encoded second audio data corresponding to respective fields. Alternatively, however, at least some of the encoded static cut image data, the encoded dynamic cut video data, the encoded first audio data, and the encoded second audio data may be stored in an Internet server such as a content download server or a streaming server, and the static cut image data field 310, the dynamic cut video data field 312, the first audio data field 314, or the second audio data field 316 corresponding to the stored data may include resource location information such as a URL or a streaming source address associated with the stored data.

In FIG. 5, each field may be further subdivided into a plurality of fields. For example, the dynamic cut video data field 312 may include a header 312A, dynamic cut picture data 312B, and an end-of-field indicator 312C. The header 312A may include information such as identification information of a corresponding dynamic cut, a size of the picture data 312B, and an encoding scheme. As mentioned above, the picture data field 312B may include a code stream for encoded dynamic cut video data for the corresponding dynamic cut, or may include an address of the download server or the streaming source storing a compressed video file. Meanwhile, the dynamic cut attribute information field 322 may include a header 322A, attribute data 322B of the corresponding dynamic cut, and an end-of-field indicator 322C. The attribute data 322B may include information illustrated in FIG. 4.

Although the dynamic cut video data field 312 and the dynamic cut attribute information field 322 have been described as an example, the other fields may be allocated with data in a similar manner. Meanwhile, although not shown in FIG. 5, additional fields such as a transition cut image data field or a caption clip data field may be provided in the video content frame. In an alternative embodiment, a still image for each dynamic cut, e.g., a first frame image, may be additionally included in the video content frame of FIG. 5 for reference.

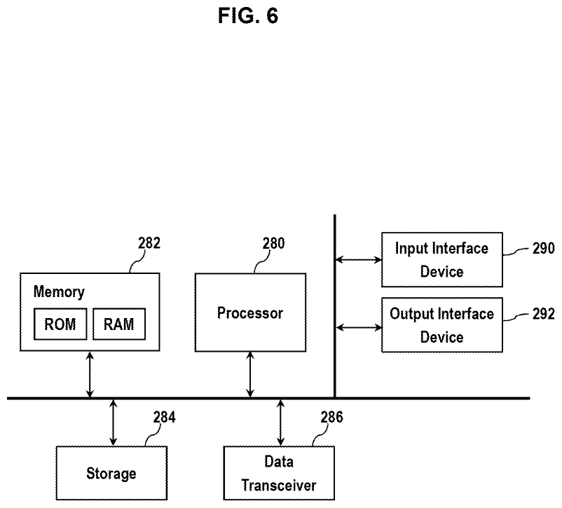

FIG. 6 is a block diagram showing a physical configuration of the video content providing apparatus shown in FIG. 2. The video content providing apparatus may include a processor 280, a memory 282, a storage 284, and a data transceiver 286. In addition, the video content providing apparatus may further include an input interface device 290 and an output interface device 292. The components of the video content providing apparatus may be connected by a bus to communicate with each other.

Processor 280 may execute program instructions stored in the memory 282 and/or the storage 284. The processor may include a central processing unit (CPU) or a graphics processing unit (GPU), or may be implemented by another kind of dedicated processor suitable for performing the method according to the present disclosure. The processor 280 may execute program instructions for executing the content generating method according to the present disclosure. The program instructions enables the creator to edit each scene of the original contents to be combined, insert the caption and/or the cursor, concatenate edited scene images, and add the second audio such as the narration, the sound effect, and the background music. The program instructions may generate the video content by classifying the cuts into one of the static cut, the dynamic cut, and the transition cut according to a certain rule and combining the content elements and their attribute information into a single frame form, and provide the video content in a file format or by the streaming.

The memory 282 may include, for example, a volatile memory such as a random access memory (RAM) and a nonvolatile memory such as a read only memory (ROM). The memory 282 may load the program instructions stored in the storage 284 to provide to the processor 280 so that the processor 280 may execute the program instructions. In particular, according to the present disclosure, the memory 282 may temporarily store the original contents, the content elements, the content element attribute information, and the video content generated finally.

The storage device 284 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD). The storage 284 may store program instructions for implementing the content generation method according to the present disclosure. In addition, the storage 284 may store data that needs to be stored for a long time among the original contents, the content elements, the content element attribute information, and the video content generated finally.

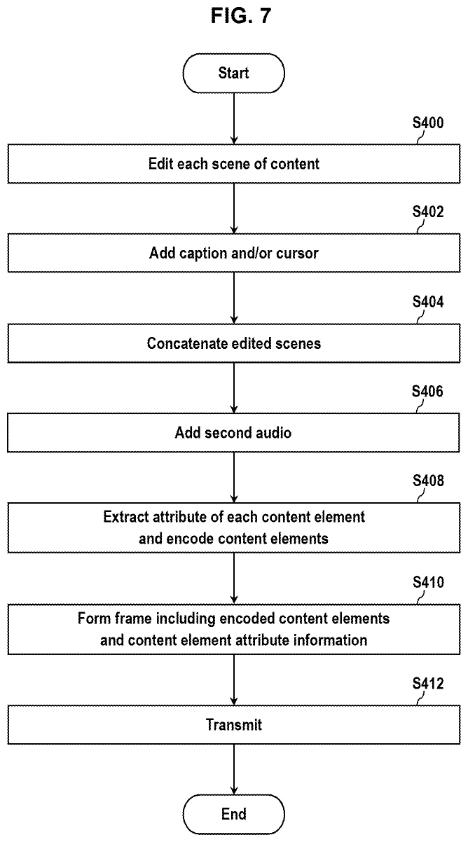

FIG. 7 is a flowchart illustrating the video content providing method according to an exemplary embodiment of the present disclosure.

The content editor 200 may edit each scene or cut of the video content in response to the creator's manipulation of the input interface device 290 (operation 400). After the editing of the scenes is completed, the content editor 200 may insert the caption or the cursor into the video in response to the manipulation input of the creator (operation 402). When adding the caption, the content editor 200 may specify a font, a size, a background, the caption transparency, and other effects of the caption. The content editor 200 may concatenate and combine two or more scenes in response to the manipulation input of the creator (operation 404). The content editor 200 may introduce the transition effect between two consecutive scenes being concatenated according to the manipulation input of the creator, so that the scene transitions smoothly. The content editor 200 may add second audio including at least one of the narration input through a microphone, the other sound effect, and/or the background music to the concatenated content according to the manipulation input of the creator (operation 406).

The video content to which the second audio has been added may be output through the output interface device 292, i.e., the display 260 and the speaker 262, for testing and confirmation by the creator. However, according to the present disclosure, the video content data stored in the storage does not have a form that is to be output through the output interface device 292, but the content elements constituting the video content and their attribute information are separately stored. In operation 408, the content attribute extractor 220 extracts the attribute information for each content element. The encoder 230 encodes individual content elements such as the image cuts, the first audio, the second audio, and the caption. The formatter 250 forms the video content frame according to a certain format based on the encoded content elements and content element attribute information to store in the storage (operation 410). The video content frame may be transmitted to the content consumer in the file format or by streaming (operation 412).

In case where the video content frame is provided in the file format, at least some portion of the video content frame file may be in the form of a web document. The web document may be written in a markup language such as Hypertext Markup Language (HTML) and Extensible Markup Language (XML), and may include a client script to identify and combine the content elements. However, the present disclosure is not limited thereto, and the video content frame file may include other types of identifiers for identifying the content elements or may be a document of another type. The video content frame may be played by the video content reproducing apparatus of the content consumer.

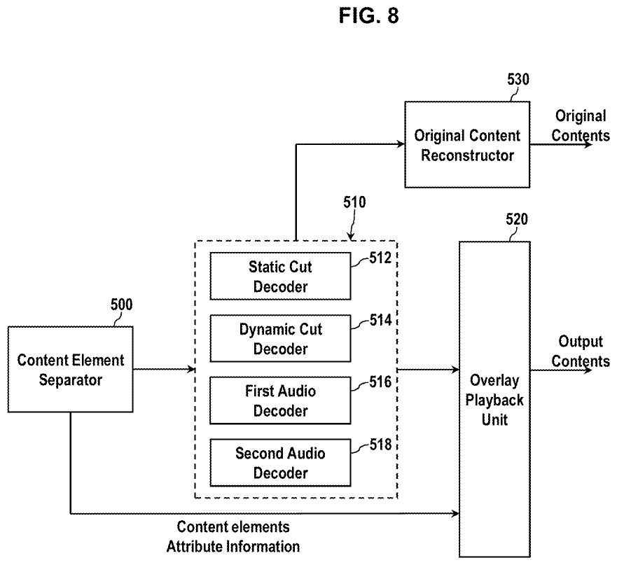

FIG. 8 is a functional block diagram of the video content reproducing apparatus according to an exemplary embodiment of the present disclosure. The video content reproducing apparatus, which is suitable for receiving the video content generated by the video content providing apparatus of FIG. 2 in the file format or by streaming and reproducing the video content, may include a content element separator 500, and a decoder 510, an overlay playback unit 520, and an original content restoration unit 530.

The content element separator 500 receives the video content frame of the format of FIG. 5 and separates the content elements. That is, the content element separator 500 may separate the encoded static cut image data for each static cut, the encoded dynamic cut video data for each dynamic cut, the encoded first audio data for each of the first audio clips, and the encoded second audio data for each of the second audio clips from the video content frame. In addition, the content element separator 500 may separate the static cut attribute information, the dynamic cut attribute information, the transition cut attribute information, and the first and the second audio attribute information, the caption clip attribute information, and the cursor clip attribute information from the video content frame. Depending on the configuration of the video content frame, the content element separator 500 may additionally separate the transition cut video data or the caption clip data. In case where at least some of the video content frame includes the resource location information instead of the code stream, the content element separator 500 may acquire the corresponding code stream based on the resource location information.

The decoder 510 may include a static cut decoder 512, a dynamic cut decoder 514, a first audio decoder 516, and a second audio decoder 518. The static cut decoder 512 may receive the encoded static cut image data from the content element separator 500 and decode such data to restore the original image for the corresponding static cut. The dynamic cut decoder 514 may receive the encoded dynamic cut video data and decode such data to restore the original video for the corresponding dynamic cut. The first audio decoder 516 may receive the encoded first audio data and decode such data to restore the original audio for the corresponding first audio clip. The second audio decoder 518 may receive the encoded second audio data and decode such data to restore the original audio for the second audio clip.

The overlay playback unit 520 may receive the content elements such as the original image for each static cut, the original video for each dynamic cut, the original audio for the first and the second audio clips, and the caption clip from the decoder 510. In addition, the overlay playback unit 520 may receive the static attribute information, the dynamic cut attribute information, the transition cut attribute information, and the first and the second audio attribute information, the caption clip attribute information, and the cursor clip attribute information from the content element separator 500. The overlay playback unit 520 may synchronize and overlay the content elements based on their attribute information, reconstruct the video content generated by the video content providing apparatus of FIG. 2, and renders the video content as a video through the display 260 and the speaker 262.

The original content reconstructor 530 may output each content element and its attribute information according to an instruction of a user of the video content reproducing apparatus. Accordingly, a content consumer using the video content reproducing apparatus may acquire the video content elements, e.g., the original video and audio, during a process of reproducing the video content to reproduce the video content in a form that some of the content elements such as a certain caption or narration is excluded or re-edit the content elements to create a secondary work.

The video content reproducing apparatus according to an exemplary embodiment of the present disclosure may be implemented based on a program executed by a processor in a data processing device including a processor, a memory, and a storage similarly to the video content providing apparatus shown in FIG. 6. An example of the program may include a web browser or a plug-in added to the web browser. The web browser or the plug-in may receive the video content in the form of a file or a stream and reproduce the video content. In such a case, the control function of the web browser or the plug-in for excluding or storing a certain content element may be implemented in a form of a context drop-down menu displayed when a mouse right button is clicked.

As mentioned above, an implementation of the method according to exemplary embodiments of the present disclosure can be implemented by computer-readable program codes or instructions stored on a computer-readable intangible recording medium. The computer-readable recording medium includes all types of recording device storing data which can be read by a computer system. The computer-readable recording medium may be distributed over computer systems connected through a network so that the computer-readable program or codes may be stored and executed in a distributed manner.

The computer-readable recording medium may include a hardware device specially configured to store and execute program instructions, such as a ROM, RAM, and flash memory. The program instructions may include not only machine language codes generated by a compiler, but also high-level language codes executable by a computer using an interpreter or the like.

Some aspects of the present disclosure described above in the context of the device may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by use of a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1-20. (canceled)

21. A method of storing a snack culture content, comprising:
receiving, from a server, a snack culture content comprising a video object, an audio object, a caption object, and a cursor object;
separating the video object, the audio object, the caption object, and the cursor object from a received snack culture content;
classifying the video object separated from the snack culture content in a cut unit according to a preset rule classifying each of consecutive frames of still images, consecutive frames of moving picture, and consecutive frames with a transition effect into a separate independent cut; and
compressing and storing the snack culture content in a format in which the video object classified in the cut unit is synchronized with the audio object, the caption object, or the cursor object.

22. The method of claim 21, wherein the transition effect includes at least one of defocusing, fade-in/fade-out, washing-out, wiping, and zoom-in/zoom-out.

23. The method of claim 21, wherein compressing and storing the snack culture content in the format in which the video object classified in the cut unit is synchronized with the audio object, the caption object, or the cursor object comprises:
compressing and storing the consecutive frames of still images classified to an independent cut into a single image file.

24. The method of claim 21, wherein compressing and storing the snack culture content in the format in which the video object classified in the cut unit is synchronized with the audio object, the caption object, or the cursor object comprises:
compressing and storing the consecutive frames of moving picture classified to an independent cut into a single moving picture.

25. The method of claim 21, wherein compressing and storing the snack culture content in the format in which the video object classified in the cut unit is synchronized with the audio object, the caption object, or the cursor object comprises:
compressing and storing the consecutive frames with the transition effect classified to an independent cut into a single moving picture.

26. The method of claim 21, wherein compressing and storing the snack culture content in the format in which the video object classified in the cut unit is synchronized with the audio object, the caption object, or the cursor object comprises:
storing information of the video including information on the preset rule.

27. The method of claim 21, wherein compressing and storing the snack culture content in the format in which the video object classified in the cut unit is synchronized with the audio object, the caption object, or the cursor object comprises:
storing information of the frames of the video object classified in the cut unit synchronized with the audio object.

28. The method of claim 21, wherein compressing and storing the snack culture content in the format in which the video object classified in the cut unit is synchronized with the audio object, the caption object, or the cursor object comprises:
storing information of the frames of the video object classified in the cut unit synchronized with the caption object.

29. The method of claim 21, wherein compressing and storing the snack culture content in the format in which the video object classified in the cut unit is synchronized with the audio object, the caption object, or the cursor object comprises:
storing information of the frames of the video object classified in the cut unit synchronized with the cursor object.

30. An apparatus for storing a snack culture content, comprising:
a processor; and
a memory storing at least one program instruction to be executed by the processor,
wherein the at least one program instruction, when executed by the processor, causes the processor to:
receive, from a server, a snack culture content comprising a video object, an audio object, a caption object, and a cursor object;
separate the video object, the audio object, the caption object, and the cursor object from a received snack culture content;
classify the video object separated from the snack culture content in a cut unit according to a preset rule classifying each of consecutive frames of still images, consecutive frames of moving picture, and consecutive frames with a transition effect into a separate independent cut; and
compress and store the snack culture content in a format in which the video object classified in the cut unit is synchronized with the audio object, the caption object, or the cursor object.

31. The apparatus of claim 30, wherein the transition effect includes at least one of defocusing, fade-in/fade-out, washing-out, wiping, and zoom-in/zoom-out.

32. The apparatus of claim 30, wherein the program instruction causing the processor to compress and store the snack culture content in the format in which the video object classified in the cut unit is synchronized with the audio object, the caption object, or the cursor object comprises:
an instruction causing the processor to compress and store the consecutive frames of still images classified to an independent cut into a single image file.

33. The apparatus of claim 30, wherein the program instruction causing the processor to compress and store the snack culture content in the format in which the video object classified in the cut unit is synchronized with the audio object, the caption object, or the cursor object comprises:
an instruction causing the processor to compress and store the consecutive frames of moving picture classified to an independent cut into a single moving picture.

34. The apparatus of claim 30, wherein the program instruction causing the processor to compress and store the snack culture content in the format in which the video object classified in the cut unit is synchronized with the audio object, the caption object, or the cursor object comprises:
an instruction causing the processor to compress and store the consecutive frames with the transition effect classified to an independent cut into a single moving picture.

35. The apparatus of claim 30, wherein the program instruction causing the processor to compress and store the snack culture content in the format in which the video object classified in the cut unit is synchronized with the audio object, the caption object, or the cursor object comprises:
an instruction causing the processor to store information of the video including information on the preset rule.

36. The apparatus of claim 30, wherein the program instruction causing the processor to compress and store the snack culture content in the format in which the video object classified in the cut unit is synchronized with the audio object, the caption object, or the cursor object comprises:
an instruction causing the processor to store information of the frames of the video object classified in the cut unit synchronized with the audio object.

37. The apparatus of claim 30, wherein the program instruction causing the processor to compress and store the snack culture content in the format in which the video object classified in the cut unit is synchronized with the audio object, the caption object, or the cursor object comprises:
an instruction causing the processor to store information of the frames of the video object classified in the cut unit synchronized with the caption object.

38. The apparatus of claim 30, wherein the program instruction causing the processor to compress and store the snack culture content in the format in which the video object classified in the cut unit is synchronized with the audio object, the caption object, or the cursor object comprises:
an instruction causing the processor to store information of the frames of the video object classified in the cut unit synchronized with the cursor object.
